(19) United States
(12) Patent Application Publication
(10) Pub. No.: US 2015/0168874 A1
(43) Pub. Date: Jun. 18, 2015

(54) DEVELOPING APPARATUS

(71) Applicant: CANON KABUSHIKI KAISHA, Tokyo (JP)

(72) Inventor: Masahiro Ootsuka, Tokyo (JP)

(21) Appl. No.: 14/566,568

(22) Filed: Dec. 10, 2014

(30) Foreign Application Priority Data
Dec. 12, 2013 (JP) 2013-257158

(51) Int. Cl. G03G 15/09

(52) U.S. Cl. CPC G03G 15/0921

(57) ABSTRACT

A stripping position at which a magnetic force in a direction normal to a developing sleeve is zero or smallest is disposed upstream, in a rotating direction of the developing sleeve, from a point of contact on a tangent to the developing sleeve, the tangent passing through an end of a partition that separates a developing chamber and a recovery chamber from each other.

### BACKGROUND OF THE INVENTION

1. Field of the Invention

The present invention relates to developing apparatuses for use in image forming apparatuses that form an image using an electrophotographic system, and in particular, it relates to a developing apparatus for use in image forming apparatuses, such as a copying machine, a printer, a FAX, and a multi-function machine having the above functions.

2. Description of the Related Art

A related-art image forming apparatuses using an electrophotographic system uniformly charges the surface of a generally drum-shaped photosensitive member serving as an image bearing member with a charger and exposes the charged photosensitive member to light with an exposing device depending on image data, thereby forming an electrostatic latent image on the photosensitive member. The electrostatic latent image formed on the photosensitive member is visualized into a toner image with toner in a developer using a developing apparatus.

A developing apparatus that uses a two-component developer generally needs to mix a nonmagnetic toner and a magnetic carrier in a developer container for development and is thus provided with a circulation passage for circulating the developer. For example, a developing apparatus 1 that uses a two-component developer has a configuration shown in FIG. 3 (For example, refer to Japanese Patent Laid-Open No. 5-333691 (Patent Literature 1)). The developing apparatus 1 includes a developer container 2 that contains a developer and a developing sleeve 8 serving as a developer bearing member at an opening of the developer container 2 facing a photosensitive drum 10. The developing apparatus 1 has a developing chamber 4 and a recovery chamber 3, which are partitioned by a partition 7, at the upper and lower parts in the developer container 2 opposite to the opening and form a circulation passage therebetween. The developing apparatus 1 is configured such that the developing chamber 4, which supplies a developer to the developing sleeve 8, and the recovery chamber 3, which recovers the developer after development from the developing sleeve 8, are functionally separated and is called a function-separated developing apparatus. With the configuration of the developing apparatus 1, the developer after development, whose density is decreased, is not immediately supplied to the developing sleeve 8, and thus, density unevenness can be reduced.

Another known example of the function-separated developing apparatus is disclosed in Japanese Patent Laid-Open No. 2004-205706 (Patent Literature 2). This is configured such that the positional relationship between the developing chamber 4 and the recovery chamber 3 is reverse to that in Patent Literature 1, in which the developing chamber 4 is located below the recovery chamber 3. This configuration allows the developer to be drawn out of the developing chamber 4 into the recovery chamber 3 also by the rotation of the developing sleeve 8, thus reducing stagnation of the developer at the drawing-up side.

However, the configuration of Patent Literature 2 has the following problems although it can reduce stagnation of the developer.

Since the recovery chamber 3 for recovering the developer from the developing sleeve 8 is located above the developing chamber 4, a position at which the developer is stripped from the developing sleeve 8 is above the developing sleeve 8. However, there is a possibility that part of the developer stripped in a direction of a tangent to the developing sleeve 8 is not recovered into the recovery chamber 3 depending on the position at which the developer is stripped from the developing sleeve 8. The unrecovered developer can be supplied onto the developing sleeve 8 again to drag over the developing sleeve 8, thus causing density unevenness.

### SUMMARY OF THE INVENTION

The present invention provides a developing apparatus in which dragging of a developer over a developer bearing member can be reduced in a function-separated developing apparatus in which a recovery chamber for recovering a developer is located above a supply chamber that supplies the developer.

Further features of the present invention will become apparent from the following description of exemplary embodiments with reference to the attached drawings.

### BRIEF DESCRIPTION OF THE DRAWINGS

FIG. 1 is a cross-sectional view of a developing apparatus according to a first embodiment of the present invention.

FIG. 2 is a diagram illustrating an image forming apparatus of the first embodiment.

FIG. 3 is a diagram illustrating circulation of a developer in a longitudinal direction of a developing apparatus of related art.

FIG. 4 is a diagram illustrating circulation of a developer in a longitudinal direction of the developing apparatus of the first embodiment.

FIG. 5 is a diagram illustrating a magnetic force and a stripping position.

FIG. 6 is a diagram illustrating the behavior of the developer depending on the stripping position.

FIG. 7A is a cross-sectional view of the vicinity of a recovery chamber and a developing sleeve of the first embodiment.

FIG. 7B is a cross-sectional view of the vicinity of the recovery chamber and the developing sleeve of the first embodiment.

FIG. 8 is a cross-sectional view of a developing apparatus according to a third embodiment of the present invention.

FIG. 9 is a diagram illustrating the positional relationship between a stirring chamber and the apex of a partition.

FIG. 10 is a cross-sectional view of a developing apparatus according to a second embodiment of the present invention.

FIG. 11A is a diagram illustrating the relationship between the position of a partition and a stripping position of the second embodiment.

FIG. 11B is a diagram illustrating the relationship between the position of a partition and a stripping position of the second embodiment.

### DESCRIPTION OF THE EMBODIMENTS

Embodiments of a developing apparatus and an image forming apparatus of the present invention will be described hereinbelow with reference to the attached drawings. Although this developing apparatus is used in an image forming apparatus, described below, it is not limited thereto.

### First Embodiment

### Image Forming Apparatus

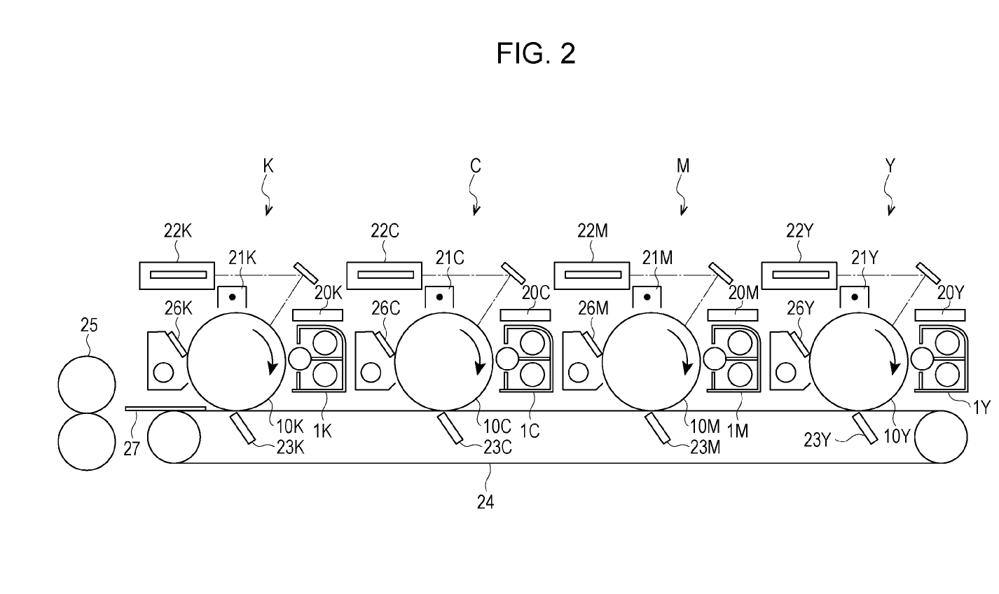

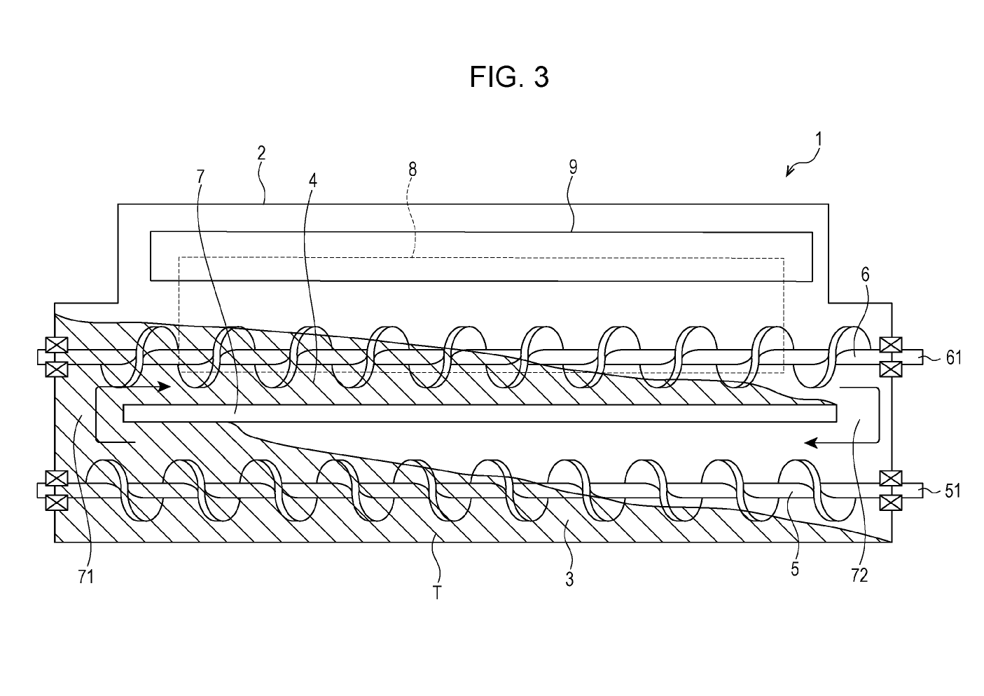

FIG. 2 shows a processing unit of a full-color image forming apparatus of this embodiment. The configuration and operation of the main body of the image forming apparatus will be described hereinbelow.

As shown in FIG. 2, the image forming apparatus has image-forming sections (stations) for forming yellow (Y), magenta (M), cyan (C), and black (K) images. The stations form Y, M, C, K images, respectively. The stations have substantially the same configuration. Thus, for example, a developing apparatus 1 refers to a developing apparatus 1Y, a developing apparatus 1M, a developing apparatus 10, and a developing apparatus 1K in the Y, M, C, or K stations, respectively.

First, the operation of the entire image forming apparatus of will be described with reference to FIG. 2. A photosensitive drum 10 serving as an image bearing member is rotatably provided. The photosensitive drum 10 is uniformly charged by a primary charger 21 and is exposed to light that is modulated in accordance with an information signal by a light-emitting element 22, such as a laser, to form a latent image. The latent image is visualized into a developed image (a toner image) by the developing apparatus 1 through the following process. The toner image is transferred by a first transfer charger 23 onto transfer paper 27, which is a recording medium, conveyed by a transfer-material conveying sheet 24 station by station and is thereafter fixed by a fixing unit 25 to form a permanent image. A transfer residual toner on the photosensitive drum 10 is removed using a cleaning unit 26. Toner in the developer consumed in image formation is replenished from a toner replenishment tank 20. Although an example in which a method of directly transferring toner images onto the transfer paper 27, which is a recording medium, conveyed by the transfer-material conveying sheet 24 from the photosensitive drums 10M, 100, 10Y, and 10K has been described here, the present invention is not limited thereto. The present invention can also be applied to an image forming apparatus with a configuration in which an intermediate transfer member is provided instead of the transfer-material conveying sheet 24, color toner images are primarily transferred onto the intermediate transfer member, and then the composite color toner images are collectively secondarily transferred onto the transfer paper 27.

### Description of Two-Component Developer

Next, a two-component developer (toner) used in this embodiment will be described.

The toner consists of colored particles in which a binder resin, a coloring agent, and an external additive, such as colloidal silica fine powder, are added, as necessary. The toner is a negative charge polyester resin, and in this embodiment, it has a volume average particle diameter of 7.0 μm. The toner may have an average particle diameter of 2 μm or more and 10 μm or less, and preferably, 4 μm or more and 8 μm or less.

Examples of the carrier include surface-oxidized or -unoxidized metals, such as iron, nickel, cobalt, manganese, chromium, and rare earths, alloys thereof, and oxide ferrites. A method for manufacturing these magnetic particles is not particularly limited. This embodiment uses a carrier having a volume average particle diameter of 40 μm, a resistivity of 5×10⁸ Ωcm, and a magnetization level of 260 emu/cc. The average particle diameter of the carrier may be 20 μm or more and 80 μm or less, and preferably, 30 μm or more and 60 μm or less. The magnetization level may be 100 emu/cc or higher and 400 emu/cc or lower, and preferably, 200 emu/cc or higher and 300 emu/cc or lower.

This embodiment uses a developer in which the above toner and carrier are mixed at a ratio by weight of 8:92. The mixing ratio of the toner to the carrier may be 4% or higher and 14% or less by wt %, and preferably, 6% or higher and 10% or lower.

### Measuring Method

The volume average particle diameter of the toner used in this embodiment was measured by the following devices and method.

For measuring devices, a Coulter counter TA-II model (manufactured by Coulter Corporation) and an interface and a HP Compaq dc7100 for outputting a number average distribution and a volume average distribution (manufactured by Nikkaki) were used. A 1% NaCl solution of primary sodium chloride in water was used as an electrolyte solution.

A method for measurement is as follows. 0.1 ml of a surface activating agent, preferably, alkyl benzene sulfonate, was added as a dispersant into 100 to 150 ml of the electrolyte solution, described above, to which 0.5 to 50 mg of a test sample was added.

The electrolyte solution in which the sample was suspended was subjected to dispersion treatment by an ultrasonic disperser for about 1 to 3 minutes. A volume average distribution was obtained by measuring 2 to 40 μm of particles using the Coulter counter TA-II and a 100 μm aperture. A volume average particle diameter was obtained from the thus-obtained volume average distribution.

The resistivity of the magnetic carrier used in this embodiment was measured using a method of obtaining the resistivity of the carrier from an electric current flowing through a circuit. Specifically, a sandwich type cell with a measurement electrode area of 4 cm² and an electrode-to-electrode interval of 0.4 cm was used, and a voltage E (V/cm) was applied between the electrodes under a pressure of 1 kg on one of the electrodes. The volume average particle diameter of the magnetic particles was measured using a laser-diffraction particle size distribution measuring device HEROS (manufactured by JEOL Ltd.) in such a manner that a range of a particle diameter 0.5 to 350 μm is logarithmically divided into 32 on a volume basis. The numbers of particles in the individual channels were measured. A volume 50% median diameter is determined as the volume average particle diameter from the measurement result.

The magnetic characteristics of the magnetic carrier used in this embodiment were measured using a vibrating sample magnetometer BHV-30 (manufactured by Riken Denshi Co., Ltd.). The magnetic characteristic value of the carrier powder was measured for external magnetic fields of 795.7 kA/m and 79.58 kA/m. A test sample of the magnetic carrier was created in a state in which it is sufficiently densely packed in a cylindrical plastic container. In this state, a magnetizing moment was measured, the actual weight of the filled sample was measured, and the intensity of magnetization (emu/g) was obtained. An intensity of magnetization per unit volume can be determined by obtaining the true specific gravity of the magnetic carrier particles using, for example, a dry automatic densitometer Akyupikku 1330 (manufactured by Shimadzu Corporation) and multiplying the thus-obtained intensity of magnetization by the true specific gravity.

### Developing Apparatus

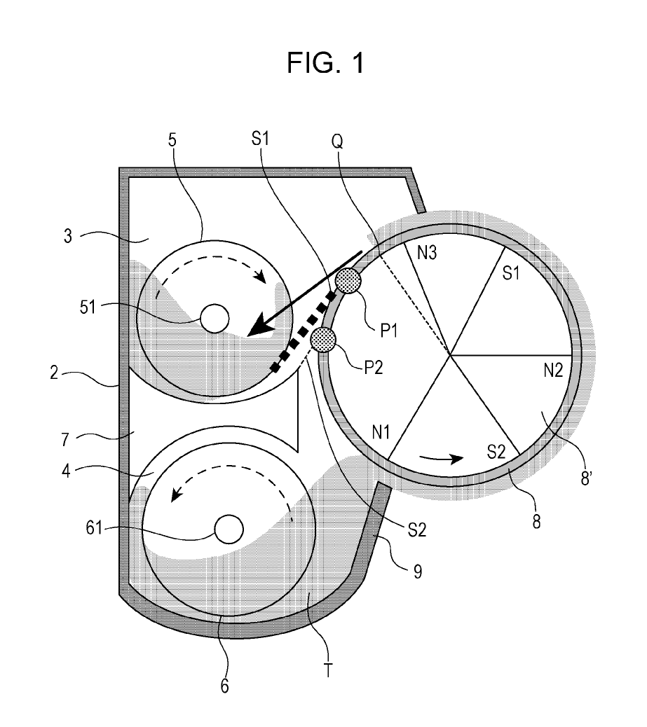

Subsequently, the developing apparatus 1 will be described in detail. As shown in FIG. 1, the developing apparatus 1 of this embodiment includes a developer container 2 that contains a two-component developer including a nonmagnetic toner and a magnetic carrier. The developer container 2 has an opening and a rotatable developing sleeve 8 serving as a developer bearing member in such a manner that it is exposed from the opening. Furthermore, a regulating blade 9 serving as a regulating member that regulates the layer thickness of the developer born on the surface of the developing sleeve 8 is provided below the developing sleeve 8 in the direction of gravity.

The developer container 2 is partitioned vertically to a developing chamber 4 and a recovery chamber 3 by a partition 7 extending in a direction perpendicular to a paper surface. A developer T is contained in the developing chamber 4 and the recovery chamber 3. The developing chamber 4 and the recovery chamber 3 communicate with each other at both ends thereof to form a circulation passage that circulates the developer T between the developing chamber 4 and the recovery chamber 3. The recovery chamber 3 is disposed above the developing chamber 4. The developing chamber 4 is opposed to the circumferential surface of the developing sleeve 8 and supplies the developer T to the developing sleeve 8. The recovery chamber 3 is opposed to the circumferential surface of the developing sleeve 8 and recovers the developer T from the developing sleeve 8. The developing apparatus 1 of this embodiment has a so-called function-separated configuration in which the developing chamber 4 that supplies the developer T to the developing sleeve 8 and the recovery chamber 3 that recovers the developer T from the developing sleeve 8 are separately provided.

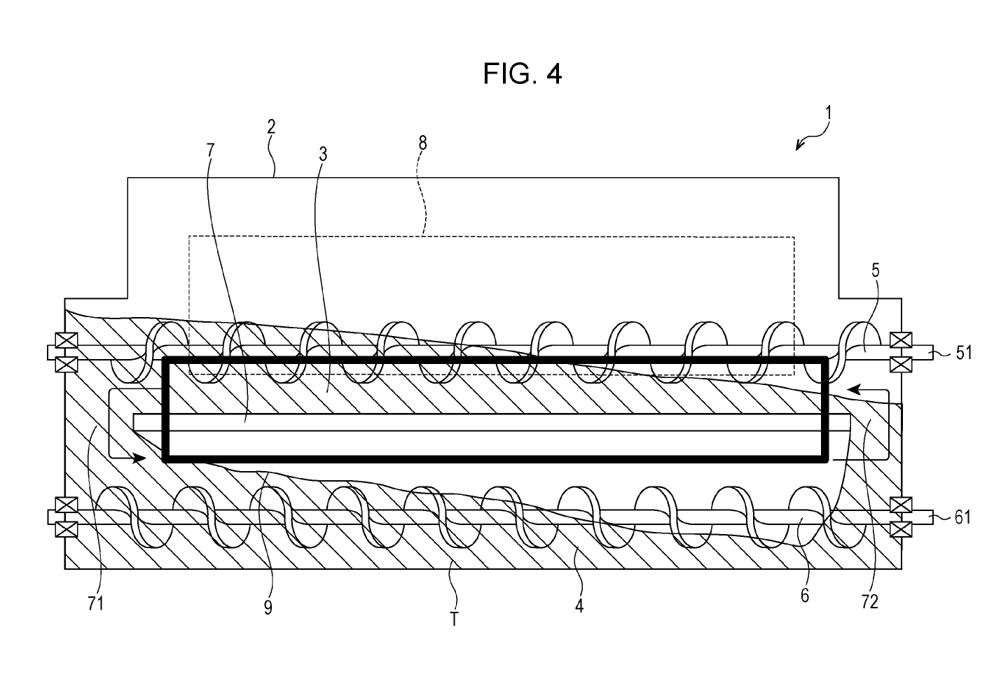

The developing chamber 4 and the recovery chamber 3 have first and second conveying screws 6 and 5 serving as conveying units for mixing and conveying the developer T and circulating it in the developer container 2, respectively. The first conveying screw 6 serving as a first conveying member is disposed substantially in parallel to the bottom of the developing chamber 4 along the axial direction of the developing sleeve 8 and conveys the developer T in the developing chamber 4 in one direction along the axial direction. The second conveying screw 5 serving as a second conveying member is disposed on the bottom of the recovery chamber 3 substantially in parallel to the first conveying screw 6 and conveys the developer T in the recovery chamber 3 in a direction opposite to that with the first conveying screw 6. Thus, the developer T in the developing apparatus 1 circulates between the developing chamber 4 and the recovery chamber 3 through communicating portions 71 and 72 in FIG. 4 by the rotation of the first and second conveying screws 6 and 5.

The developing sleeve 8 is made of a nonmagnetic material, in which a magnet roller 8′ serving as a magnetic field generating unit is disposed therein in a non-rotating state. This magnet roller 8′ includes a plurality of magnetic poles in the circumferential direction of the developing sleeve 8. Specifically, the magnet roller 8′ includes a development pole N2 and magnetic poles S1, N1, S2, and N3 for conveying the developer T. Among them, the first magnetic pole N3 and the second magnetic pole N1 having the same polarity are disposed side by side close to the interior of the developer container 2 to form a pair of magnetic poles. A repulsive magnetic field is formed between the pair of magnetic poles to form a barrier to the developer T, thus separating the developer T in the recovery chamber 3.

The diameter of the developing sleeve 8 is 20 mm, the diameter of the photosensitive drum 10 is 30 mm, and the closest distance between the developing sleeve 8 and the photosensitive drum 10 is set to about 300 μm. The developing apparatus 1 is configured to perform development in a state in which the developer T conveyed to a developing region is in contact with the photosensitive drum 10. This developing sleeve 8 is made of a nonmagnetic material, such as aluminum or stainless steel, in which the magnet roller 8′ serving as a magnetic field generating unit is disposed in a non-rotating state.

The developing sleeve 8 rotates in the direction of the arrow (counterclockwise) in FIG. 1, and the layer thickness is regulated by cutting a nap of a magnetic bush using the regulating blade 9. The developing sleeve 8 bears the regulated two-component developer, conveys it to the developing region facing the photosensitive drum 10, and supplies the developer T to an electrostatic latent image formed on the photosensitive drum 10, thereby developing the latent image. To enhance the developing efficiency, that is, the attaching rate of the toner to the latent image, a developing bias voltage in which a DC voltage and an AC voltage are superposed is applied the developing sleeve 8 from a power source. This embodiment uses a DC voltage of −500 V and an AC voltage with a peak-to-peak voltage Vpp of 800V and a frequency f of 12 kHz. However, the value of the DC voltage and the waveform of the AC voltage are not limited thereto. In the two-component magnetic brush developing method, application of an AC voltage generally enhances the developing efficiency to increase the image quality, but fogging tends to occur. Thus, this embodiment prevents the fogging by providing a potential difference between the DC voltage applied to the developing sleeve 8 and the charging potential (that is, a blank portion potential) of the photosensitive drum 10.

In the developing region, the developing sleeve 8 of the developing apparatus 1 moves in a direction opposite to the moving direction of the photosensitive drum 10, and the peripheral-speed ratio thereof is 1.7 times that of the photosensitive drum 10. The peripheral-speed ratio is set between 0.5 and 2.5 times, and preferably, between 1.0 and 2.0 times. Although the developing efficiency increases as the moving velocity increases, excessively high moving velocity causes scattering of the toner, degradation of the developer T, and thus, it is preferably set in the above range.

The regulating blade 9 serving as a regulating member is made of a nonmagnetic material, such as plate-like aluminum, extending in the longitudinal axis of the developing sleeve 8 and is disposed upstream from the photosensitive drum 10 in the rotating direction of the developing sleeve 8. The regulating blade 9 is disposed such that an end thereof faces the developing sleeve 8 from below in the direction of gravity. In this embodiment, the regulating blade 9 is disposed at an angle of 74° to the horizontal surface of the circumferential direction of the developing sleeve 8.

Thus, both of the toner and the carrier in the developer T passes between the end of the regulating blade 9 and the developing sleeve 8 into the developing region. The cut amount of nap of a magnetic brush of the developer T born on the developing sleeve 8 is restricted by adjusting the interval (gap) between the regulating blade 9 and the developing sleeve 8, and thus the amount of the developer T to be conveyed to the developing region is adjusted. In this embodiment, the amount of the developer T per unit area on the developing sleeve 8 is restricted to 30 mg/cm² using the regulating blade 9. The interval between the regulating blade 9 and the developing sleeve 8 is set between 200 to 1,000 μm, and preferably, between 300 to 700 μm. In this embodiment, the interval is set at 400 μm.

### Circulation Configuration of Developing Apparatus

FIG. 4 is a transverse sectional view of the developing apparatus 1 of this embodiment. As shown in FIG. 4, the first conveying screw 6 is rotatably disposed in the developing chamber 4. The first conveying screw 6 is disposed at the bottom in the developing chamber 4 substantially in parallel to the axial direction (development widthwise direction). In this embodiment, the first conveying screw 6 has a screw structure in which a stirring blade made of a nonmagnetic material is provided in a spiral shape around a rotation shaft 61 made of a nonmagnetic material. The first conveying screw 6 rotates to convey the developer T in the developing chamber 4 at the bottom of the developing chamber 4 along the axial direction of the developing sleeve 8. The recovery chamber 3 is provided with the rotatable second conveying screw 5. Like the first conveying screw 6, the second conveying screw 5 has a screw structure in which a stirring blade is provided around a rotation shaft 51. The second conveying screw 5 is disposed at the bottom of the recovery chamber 3 substantially in parallel to the first conveying screw 6 and conveys the developer T in the recovery chamber 3 in a direction opposite to that with the first conveying screw 6 by rotating about the rotation shaft 51. The developer T circulates between the developing chamber 4 and the recovery chamber 3 by the rotation of the first and second conveying screws 6 and 5. In the developing apparatus 1, the developing chamber 4 and the recovery chamber 3 are disposed below and above in the vertical direction. In other words, the rotation shaft 61 of the first conveying screw 6 and the rotation shaft 51 of the second conveying screw 5 are provided at different positions in the vertical direction. The rotation shaft 51 of the second conveying screw 5 is disposed higher than the rotation shaft r of the first conveying screw 6.

The developer T from the developing chamber 4 to the recovery chamber 3 moves from below to above through the communicating portion 72, and the developer T from the recovery chamber 3 to the developing chamber 4 moves from above to below. In particular, the developer T from the developing chamber 4 to the recovery chamber 3 is moved from below upward under the pressure of the developer T standing at an end. As shown in FIG. 4, the developing apparatus 1 of this embodiment is configured such that the amount of the developer T at the communicating portion 72, which is a drawing portion, is smaller than that with a configuration in which the recovery chamber 3 is provided below the developing chamber 4. This configuration can prevent the developer T from spilling from the developer container 2 even under pressure at the drawing portion.

In this embodiment, the developer T in the developing chamber 4 is drawn into the upper recovery chamber 3 by the rotation of the developing sleeve 8. Since this configuration has an advantage in drawing the developer T over a configuration in which the recovery chamber 3 is provided below the developing chamber 4, the developer T in the developer container 2 can be stably circulated.

### Definition of Stripping Position

A stripping position Q, which is a feature of the present invention, will now be described. The stripping position Q is a position where a magnetic force Fr in the direction normal to the developing sleeve 8 is 0 between the repulsive poles N3 and N1 of the developing sleeve 8.

In this embodiment, optimizing the stripping position Q between the repulsive poles N3 and N1 reduces dragging of the developer T over the developing sleeve 8. This will be described hereinbelow in more detail.

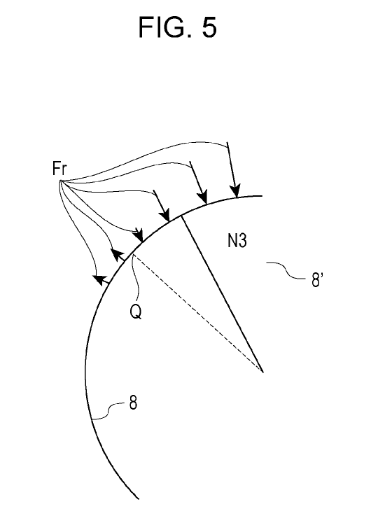

Referring to FIG. 5, the stripping position Q will be described.

In this embodiment, a component of the magnetic force F in the direction of the center (O 1) (a normal direction) of the developing sleeve 8 is defined as a magnetic force Fr of the magnetic roller 8′. This is a force attracting a magnetic carrier (a magnetic brush) carrying the toner on the developing sleeve 8 with the magnetic roller 8′ (a magnetic attracting force).

A method for calculating a magnetic force F will now be described.

The magnetic force F is calculated from Br, which are peak intensities at individual positions obtained by measuring the magnetic flux densities on the circumferential surface of the developing sleeve 8. The magnetic flux densities were measured using a Gauss meter Model 640 manufactured by Bell Inc. The Gauss meter has a rod-shaped axial probe connected to the main body of the Gauss meter. The developing sleeve 8 is fixed in a horizontal position, and the magnetic roller 8′ therein is rotatably mounted. The probe in the horizontal position is disposed at right angles to the developing sleeve 8 at a slight interval therebetween and is fixed such that the center of the developing sleeve 8 and the center of the probe are located on a substantially same horizontal plane, in which state the magnetic flux densities are measured. The magnetic roller 8′ is a cylindrical member substantially coaxial to the developing sleeve 8. The interval between the developing sleeve 8 and the magnetic roller 8′ is constant at any position. Thus, by measuring the magnetic flux density at a position of the surface of the developing sleeve 8 and in the normal direction at the position of the surface of the developing sleeve 8 while rotating the magnetic roller 8′, magnetic flux densities measured at all the positions in the circumferential direction of the developing sleeve 8 can be obtained. Bθ is uniquely determined from the measured Br.

A magnetic force Fr (unit: newton N) that acts on the circumferential surface of the developing sleeve 8 per magnetic carrier is defined as follows:

Fr=−AΔr(m·B)=−Ad/dr(|m|VB·B)=−|m|VAd/dr(B2)=−|m|VAd/dr{(Br)²+(Bθ)²}

where, m (vector, the unit of |m| is A/m) is magnetization of a magnetic carrier, |m| is a function of magnetic permeability, V (m^{s}) is the volume of a magnetic carrier, and B (B=(Br, Bθ)) is the intensity of a magnetic field due to the magnetic roller 8′, and A is a constant. Since r is set as the direction of radiation (normal direction) with respect to the surface of the developing sleeve 8, the force is directed toward the center of the developing sleeve 8.

That is, the magnetic force Fr is expressed by the following equation.

Fr=A·Δr{(Br1)2}

Accordingly, the force Fr acting on the center of the developing sleeve 8 is proportional to a lean of the sum of the square of an absolute value of Br and the square of an absolution value of BO to a direction perpendicular to the surface of the developing sleeve 8 (a direction toward the center of the developing sleeve is set to be positive (plus).

After the developer T passes through a position at a peak of the intensity of the magnetic field of the magnetic pole N3, a component of the force Fr directed to the center of the developing sleeve 8 is reversed (becomes negative) so that the developer T is stripped from the developing sleeve 8.

A point at which the component Fr of the magnetic force directed to the center of the developing sleeve 8 turns from positive to negative is taken as the stripping position Q.

Note that Fr can be substantially zero but cannot be negative between repulsive poles depending on the developing apparatus. In this case, a position at which Fr is the smallest between repulsive poles is defined as the stripping position Q.

### Specification of Stripping Position

Next, the position of the stripping position Q, which is a feature of the present invention, will now be described.

FIG. 1 is a cross-sectional view of the developing apparatus 1 of this embodiment perpendicular to the direction of the rotational axis of the developing sleeve 8. In this embodiment, as shown in FIG. 1, of internal common tangents of the developing sleeve 8 and the first conveying screw 6, a tangent whose point of contact P1 with the developing sleeve 8 is upstream in the rotating direction of the developing sleeve 8 is taken as S1. The stripping position Q is upstream of the point of contact P1 between the tangent S1 and the developing sleeve 8 in the rotating direction of the developing sleeve 8. In this embodiment, part of the developer container 2 and so on are not disposed in at least an area between the point of contact P1 and the point of contact with the second conveying screw 5 on the internal common tangent S1. Thus, the developing sleeve 8 and the second conveying screw 5 face directly on the internal common tangent S1.

Referring again to FIG. 1, of tangents passing through the apex of the partition 7 and tangent to the developing sleeve 8, a tangent whose point of contact P2 with the developing sleeve 8 is upstream in the rotating direction of the developing sleeve 8 is taken as S2. This embodiment is configured such that the stripping position Q is disposed upstream of the point of contact P2 in the rotating direction of the developing sleeve 8.

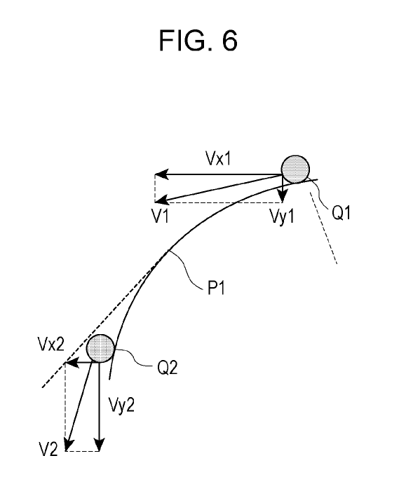

Subsequently, how the behavior of the developer T changes depending on the positional relationship between the point of contact P1 and the stripping position Q will be described with reference to FIG. 6.

The developer T is released in a direction tangent to the developing sleeve 8 after passing through the stripping position Q. When the stripping position Q is upstream of the point of contact P1 in the rotating direction (point Q1), a component Vx1 of a velocity V1 is large, and the other component Vy1 is small. This allows the developer T to be sufficiently moved in the horizontal direction, thus allowing the developer T to easily reach the second conveying screw 5 (not shown).

When the stripping position Q is downstream of the point of contact P1 in the rotating direction (point Q2), the developer T is released in a direction tangent to the developing sleeve 8 after passing through the stripping position Q. A component Vy2 of a velocity V2 is large, and the other component Vx2 is small. Thus, the developer T cannot sufficiently move in the horizontal direction. This makes it difficult for the developer T to reach the second conveying screw 5 (not shown).

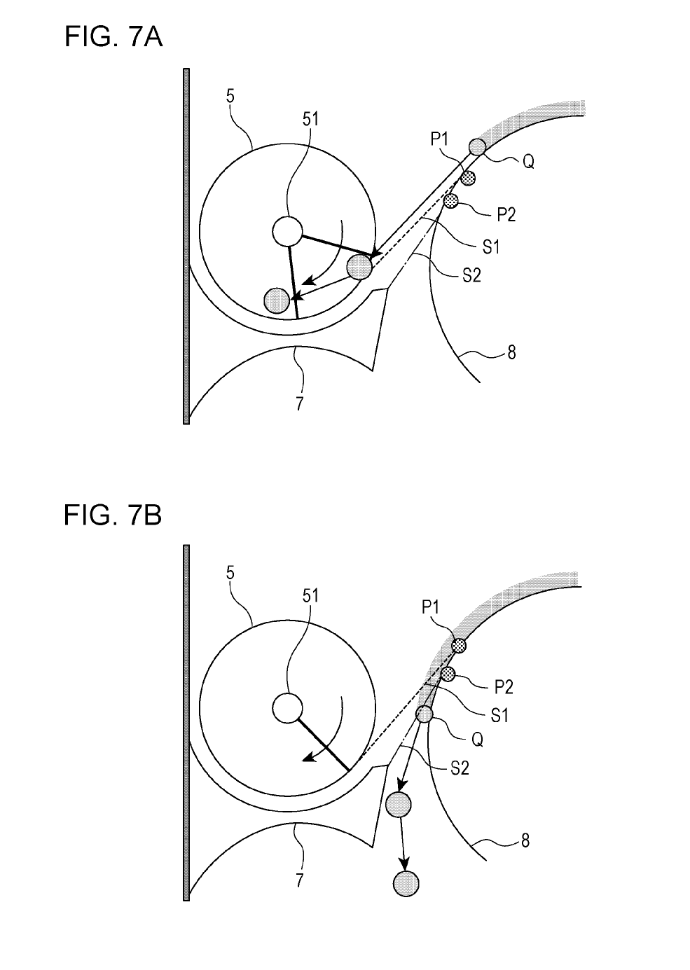

This will be described in more detail with reference to FIGS. 7A and 7B.

As in this embodiment, when the stripping position Q is upstream of the point of contact P1 in the rotating direction, the developer T stripped from the developing sleeve 8 is released in the tangential direction, as shown in FIG. 7A. Thus, the developer T is taken into the rotating area of the second conveying screw 5.

In contrast, if the stripping position Q is downstream of the point of contact P1 in the rotating direction, part of the developer T stripped from the developing sleeve 8 tends to go out of the recovery chamber 3, as shown in 7B. Thus, the stripped developer T drops in the developing chamber 4 not to the recovery chamber 3, and as a result, the stripped developer T is recovered by the developing chamber 3 without being sufficiently stirred and is immediately supplied to the developing sleeve 8, thus causing variations in T/D ratio.

As described above, the configuration of this embodiment prevents the developer T from dragging, thus providing a high-quality image.

Although, in this embodiment, the stripping position Q is upstream from the point of contact P1, the stripping position Q may be located at least upstream from the point of contact P2. This configuration allows the developer T stripped from the developing sleeve 8 to be easily moved into the recovery chamber 3. The stripping position Q may be located upstream from the point of contact P1, as in this embodiment. This is because the developer T stripped from the developing sleeve 8 is stacked at an end of the partition 7 in the recovery chamber 3, and the stacked developer T acts as a partition, thereby reducing obstruction to recovery of the developer T into the recovery chamber 3.

### Second Embodiment

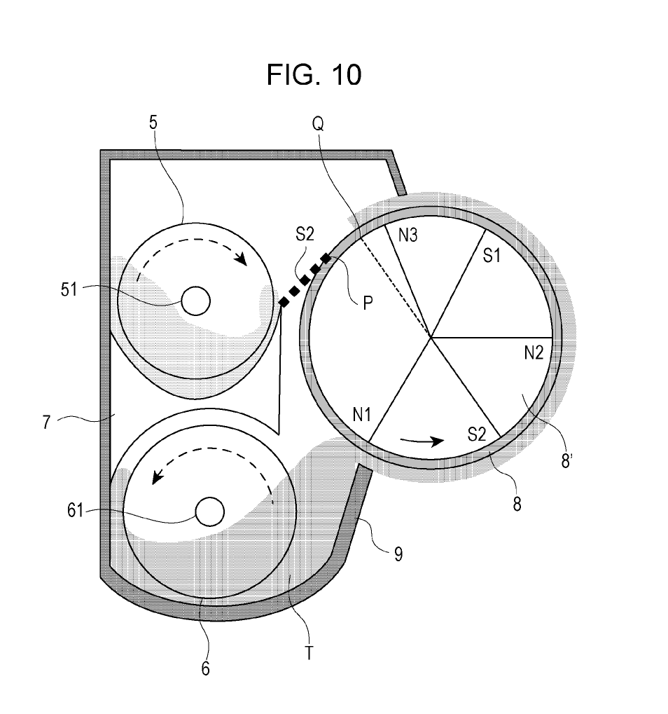

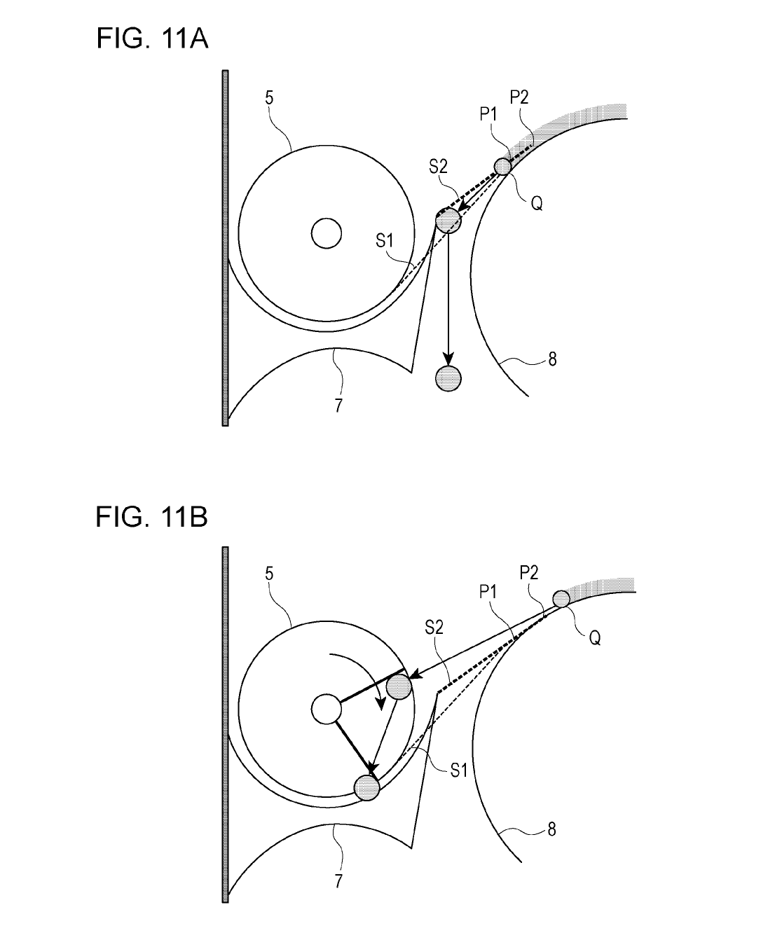

This embodiment differs from the first embodiment in the position of the apex of the partition 7 that forms the recovery chamber 3. In this embodiment, the positions of the stripping position Q and the apex of the partition 7 are defined. This will be described hereinbelow in detail. In this embodiment, the apex of the partition 7 is higher than the common tangential line S1, as shown in FIG. 11A. Thus, in this embodiment, the stripping position Q is located upstream from the point of contact P2 with the line S2 tangent to the developing sleeve 8, which is drawn so as to pass through the apex of the partition 7, in the rotating direction of the developing sleeve 8, as shown in FIGS. 10 and 11B.

Setting the height of the partition 7 and disposing the stripping position Q as in this embodiment can prevent the stripped developer T from being taken into the recovery chamber 3 and being dragged over the developing sleeve 8. In this embodiment, the partition 7 is located at the same height as that of the axis of the developing sleeve 8, whereas the present invention is not limited thereto. The height of the partition 7 may differ from that of the axis of developing sleeve 8. For example, the partition 7 may be partially located lower than the common tangential line S1, as in the first embodiment.

For example, since the amount of the developer T in the recovery chamber 3 tends to increase downstream in the conveying direction, the developer T is prone to spill from the developing sleeve 8 at the downstream side in the conveying direction. Thus, the partition 7 may be disposed higher at the downstream side in the developer conveying direction in the recovery chamber 3 and lower at the upstream side in the developer conveying direction, with the stripping position Q disposed upstream from the point P2, to increase the recovery performance.

### Third Embodiment

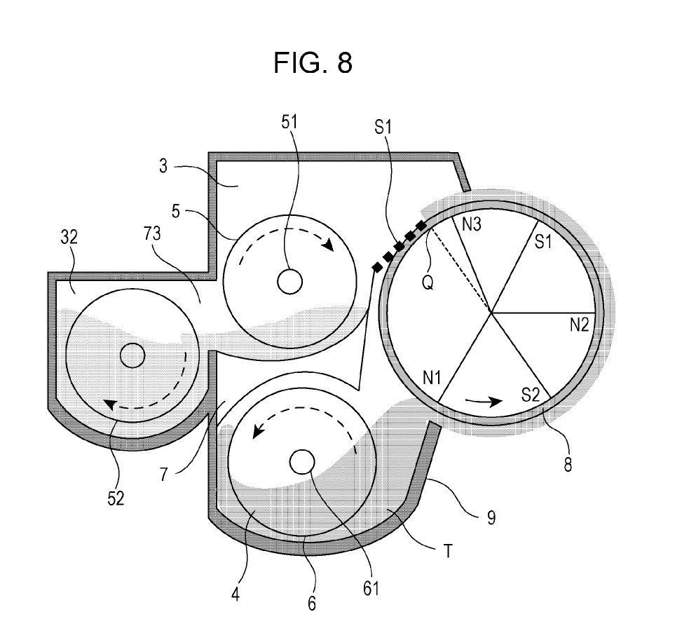

This embodiment has the same configuration as those of the first and second embodiments but differs therefrom in that the circulation passage in the developing apparatus 1 is changed. As shown in FIG. 8, this embodiment has a stirring chamber 32 in addition to the developing chamber 4 and the recovery chamber 3. This allows the developer T to circulate into the stirring chamber 32 even if the developer T in the recovery chamber 3 increases to excess, thereby preventing the developer T from spilling.

This will be described with reference to FIG. 8. In the first and second embodiments, the transfer of the developer T between the developing chamber 4 and the recovery chamber 3 is performed at the communicating portions 71 and 72 at both ends of the partition 7, as shown in FIG. 4. However, the transfer at both ends of the partition 7 causes the amount of the developer T to increase to excess at the communicating portion 71 where the developer T is transferred from above to below, thus causing a problem in that the developer T to be dragged at the communicating portion 71. Thus, as described above, this embodiment is provided with the stirring chamber 32, as shown in FIG. 8.

The stirring chamber 32 has a circulating portion 73 through which the developer T can be transferred along the longitudinal direction of the recovery chamber 31. Since the bottom of the circulating portion 73 is lower than the apex of the partition 7, the developer T is transferred to the stirring chamber 32 before spilling from the partition 7. The developer T in the stirring chamber 32 is conveyed to the developing chamber 4 for circulation, as will be described later. This can reduce an increase in the amount of the developer T at the lowermost stream portion in the developer conveying direction in the recovery chamber 3.

Referring now to FIGS. 4 and 8, circulation of the developer T will be described. First, as shown in FIG. 4, the developer T is transferred from the recovery chamber 3 to the developing chamber 4 from above to below in the direction of gravity at the circulating portion 71 at one end of the partition 7. Thereafter, the nap of the developer T on the developing sleeve 8 is cut by the regulating blade 9 by the rotation of the developing sleeve 8, and the developer T is conveyed to the developing section facing the photosensitive drum 10. After development, the developer T is taken into the recovery chamber 3. Thus, the developer T is transferred from the lower developing chamber 4 to the upper recovery chamber 3.

In such circulation of the developer T, the amount of the developer T increases at the lowermost stream portion of the second conveying screw 5 in the recovery chamber 3 in the developer conveying direction. If the developer T stands in the recovery chamber 3, the developer T spills through the gap between the partition 7 and the developing sleeve 8, thus causing dragging.

To solve this problem, a third screw 52 is provided below the second conveying screw 5, as shown in FIG. 8. The circulating portion 73 is provided between the second conveying screw 5 and the third screw 52 in parallel therewith. The relationship between the recovery chamber 3 and the stirring chamber 32 will be described with reference to FIG. 8.

When the amount of the developer T in the recovery chamber 3 has increased, the developer T is conveyed to the stirring chamber 32 through the circulating portion 73 provided above the partition 7. The developer T conveyed from the recovery chamber 4 through the circulating portion 73 is then conveyed by the third screw 52. The third screw 52 conveys the developer T in a direction opposite to that with the first conveying screw 6 in the developing chamber 4. The developer T is conveyed at the lowermost stream position of the third screw 52 in the developer conveying direction from the stirring chamber 32 to the developing chamber 4 for development. In other words, if the developer T in the recovery chamber 3 has increased to excess, this embodiment circulates the excess developer T using the stirring chamber 32, thereby preventing the developer T from spilling.

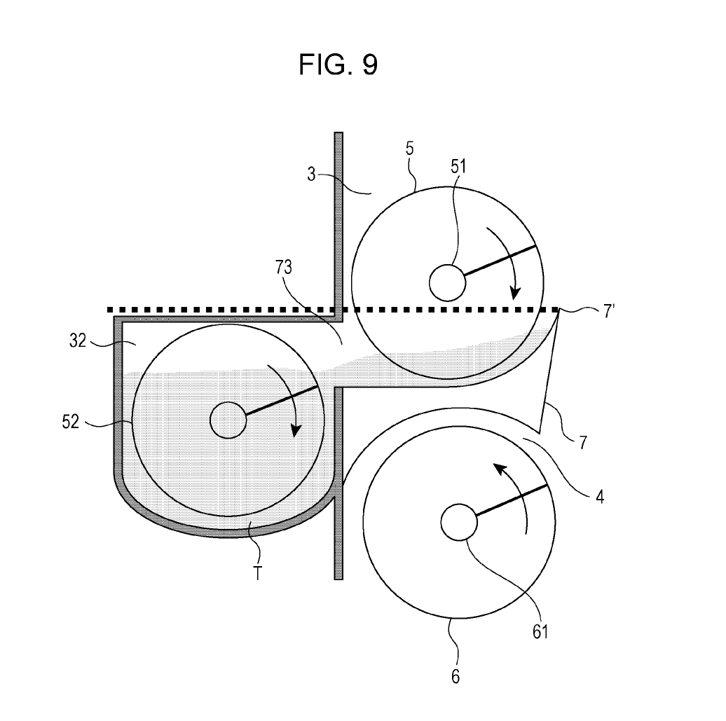

The developing apparatus 1 of this embodiment is configured such that the ceiling of the stirring chamber 32 is lower than the apex 7′ of the partition 7, as shown in FIG. 9. This reduces the amount of the developer T flowing from the stirring chamber 32 to the recovery chamber 3, thereby preventing the developer T in the recovery chamber 3 from increasing to excess. This can reduce spillover of the developer T and prevent the dragging of the developer T with a low T/D ratio after development, thereby providing a high-quality image.

### Other Embodiments

It will be appreciated that the present invention may be combinations of the first to third embodiments provided that the advantages of the present invention are offered.

Although the above embodiments are configured such that a pair of homopolar magnetic poles N3 and N1 are disposed next to each other to strip the developer T on the developing sleeve 8, the present invention is not limited thereto. For example, a heteropolar magnetic pole may be provided between the pair of magnetic poles provided that a substantially force-free area (an area in which the magnetic force is zero) is formed between the pair of magnetic poles. Also in this case, the present invention is assumed, for descriptive purpose, that s pair of homopolar magnetic poles are disposed next to each other.

The present invention provides a developing apparatus in which dragging of a developer stripped from a developer bearing member over the developer bearing member without being recovered by the recovery chamber can be reduced in a function-separated developing apparatus in which a developing chamber is disposed below a recovery chamber.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-257158, filed Dec. 12, 2013, which is hereby incorporated by reference herein in its entirety.

What is claimed is:

1. A developing apparatus comprising:
a developer bearing member configured to bear a developer including a nonmagnetic toner and a magnetic carrier and convey the developer to a developing region facing an image bearing member to develop a latent image formed on the image bearing member;
a magnet fixed in the developer bearing member and causing the developer to be born on a surface of the developer bearing member, the magnet having a plurality of magnetic poles including a pair of magnetic poles having same polarity, the magnetic poles being disposed next to each other in a circumferential direction of the developer bearing member;
a developer container containing a developer, the developer container including a developing chamber that supplies the developer to the developer bearing member, a recovery chamber disposed above the developing chamber in a vertical direction and opposed to the developer bearing member upstream from the developing chamber in a rotating direction of the developer bearing member, the recovery chamber recovering the developer from the developer bearing member, and a partition that separates the developing chamber and the recovery chamber, the developer container having a circulation passage through which the developer circulates between the developing chamber and the recovery chamber through both ends of the developing chamber and the recovery chamber;
a first conveying member rotatably disposed in the developing chamber; and
a second conveying member rotatably disposed in the recovery chamber,
wherein, in a cross section perpendicular to a rotation axis direction of the developer bearing member, a stripping position at which a magnetic force in a direction normal to the developer bearing member is smallest between the pair of magnetic poles on a circumferential surface of the developer bearing member is upstream from a point of contact in a rotating direction of the developer bearing member, the point of contact being a point of contact between the developer bearing member and a tangent to the developer bearing member, the tangent passing through an end of the partition facing the developer bearing member, the point of contact being provided upstream, in the rotating direction of the developer bearing member, from a position at which the end of the partition and the developer bearing member are closest to each other.

2. The developing apparatus according to claim 1, wherein, in a cross section perpendicular to the rotation axis direction of the developer bearing member, a stripping position at which a magnetic force in a direction normal to the developer bearing member is smallest between the pair of magnetic poles in a circumferential direction of the developer bearing member is upstream from the point of contact in the rotating direction of the developer bearing member.

3. The developing apparatus according to claim 1, wherein the stripping position is disposed higher than a rotation center of the developer bearing member in a vertical direction.

4. The developing apparatus according to claim 1, wherein the second conveying member is configured to rotate in such a way that an area facing the developer bearing member moves from above to below in a vertical direction.

5. The developing apparatus according to claim 1, wherein the first conveying member is configured to rotate in such a way that an area facing the developer bearing member moves from below to above in a vertical direction.

6. The developing apparatus according to claim 1, further comprising:
a stirring chamber disposed lower than the recovery chamber and higher than the developing chamber in a vertical direction, the stirring chamber containing the developer supplied from the recovery chamber and conveying the developer to the developing chamber; and
a third conveying member rotatably disposed in the stirring chamber and conveying the developer in the stirring chamber in a direction opposite to the conveying direction of the first conveying member.

7. The developing apparatus according to claim 1, wherein the pair of magnetic poles further includes a configuration in which a magnetic pole having a polarity opposite to that of the pair of magnetic poles is disposed between the pair of magnetic poles in such a way that a substantially force-free area is formed between the pair of magnetic poles.
